(19) United States
(12) Patent Application Publication
(10) Pub. No.: US 2025/0077904 A1
(43) Pub. Date: Mar. 6, 2025

(54) METHOD FOR DETERMINING TEMPERATURE OF REFLOW OVEN, ELECTRONIC DEVICE AND STORAGE MEDIUM

(71) Applicant: Fulian Precision Electronics (Tianjin) Co., Ltd., Tianjin (CN)

(72) Inventors: KUANG-HUI MA, New Taipei (TW); Yin-Chen Wang, Neihu (TW)

(21) Appl. No.: 18/494,106

(22) Filed: Oct. 25, 2023

(30) Foreign Application Priority Data
Aug. 29, 2023 (CN) 202311100325.2

(51) Int. Cl. G06N 5/022; B23K 3/04; F27D 19/00; G05D 23/19

(52) U.S. Cl. CPC G06N 5/022; B23K 3/04; F27D 19/00; G05D 23/1931; F27D 2019/0018

(57) ABSTRACT

A method for determining temperature of reflow oven is provided. In the method, the electronic device receives an initial setting temperature of each of at least one zone of the reflow oven and obtains target feature data of each of the at least one zone of the reflow oven by predicting the initial setting temperature through a predetermined machine learning model. The electronic device further obtains actual data of each of the at least one zone of the reflow oven corresponding to the initial setting temperature in response that the initial setting temperature meets the production requirements and determines a target setting temperature of each of the at least one zone of the reflow oven based on the preset conditions, the initial setting temperature, and the actual data.

### FIELD

The present disclosure relates to a field of intelligent manufacturing, in particular to a method for determining temperature of reflow oven, an electronic device, and a storage medium.

### BACKGROUND

With rapid development of information products, a production of a printed circuit board (PCB) is becoming more and more sophisticated and complex. Soldering in a reflow oven is a key step in the PCB production process. Different temperatures in each zone of the reflow oven (such as, a zone for preheating the PCB and a zone for cooling the PCB, etc.) of the reflow oven will affect production quality of the PCB. Therefore, it is very important to set a temperature for each furnace oven.

In related technologies, the temperature setting of each zone of the reflow oven mainly relies on experience of engineers. It is necessary to collect data and perform calculations through thermometers and other equipment to obtain multiple reference data (for example, a peak temperature), and determine whether the temperature meets production conditions based on the reference data. If the temperature does not meet the production conditions, it is necessary to wait for each zone of the reflow oven to cool down before resetting the temperature, which is not only time-consuming but also affects PCB production efficiency.

### BRIEF DESCRIPTION OF THE DRAWINGS

FIG. 1 is a block diagram of an electronic device according to an embodiment of the present disclosure.

FIG. 2 is a flowchart of a method for determining a temperature of a reflow oven according to an embodiment of the present disclosure.

FIG. 3 is a schematic view of a time-temperature curve according to an embodiment of the present disclosure.

FIG. 4 is a flowchart of a training method for a machine learning model according to an embodiment of the present disclosure.

### DETAILED DESCRIPTION

It should be noted that in the present disclosure a term “at least one” refers to one or more and “multiple” refers to two or more. “And/Or,” which describes an associative relationship of associative objects, indicates that there can be three relationships.

For example, A and/or B may indicate that A exists alone, A and B exist simultaneously, or B exists alone, where A and B may be singular or plural. The terms “first,” “second,” “third,” “fourth,” and the like, if any, in the specification and claims of the present disclosure and in the accompanying drawings are intended to discriminate between similar objects and are not intended to describe a particular order or a precedence order.

In at least one embodiment of the present disclosure, words such as “exemplary” or “for example” are used as examples, exemplifications or illustrations. Any embodiment or design described as “exemplary” or “such as” in the embodiments of the present disclosure is not to be construed as preferred or advantageous over other embodiments or designs. Specifically, the use of words such as “exemplary” or “for example” is intended to present relevant concepts in a specific way. The following embodiments and features in the embodiments may be combined with each other without conflict.

With rapid development of information products, a production of a printed circuit board (PCB) is becoming more and more sophisticated and complex. In a production line of surface adhesive technology, manufacturing of a printed circuit board requires soldering in a reflow oven. When the printed circuit board is soldered in the reflow oven, the PCB will be passed through multiple zones of the reflow oven with different temperatures (such as a zone for preheating the PCB, a zone for soaking the PCB, a zone for reflowing the PCB, and a zone for cooling the PCB, etc.). Different reflow ovens have different numbers of zones for processing the PCB. The temperature of each zone affects the quality of the printed circuit boards. If the temperature is too high, it will easily cause parts damage, solder balls, solder paste oxidation of the PCB. If the temperature is too low, it may lead to insufficient activation of the flux, so setting the temperatures is crucial to the quality of the printed circuit board.

In related technologies, the temperature setting of each zone of the reflow oven mainly relies on experience of engineers. It is necessary to collect data and perform calculations through thermometers and other equipment to obtain multiple reference data (for example, a peak temperature, etc.), and determine whether the temperature meets production conditions based on the reference data. If the temperature does not meet the production conditions, it is necessary to wait for each zone of the reflow oven to cool down before resetting the temperature, which is not only time-consuming but also affects PCB production efficiency.

To solve above issue, the present disclosure provides a method for determining temperature of a reflow oven, an electronic device, and a storage medium. The method can improve temperature control efficiency of the reflow oven and improve the production efficiency of the printed circuit board. The method provided by the embodiments of the present disclosure can be applied to one or more electronic devices.

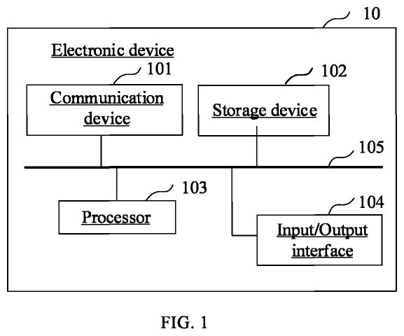

FIG. 1 is a block diagram of an electronic device provided by an embodiment of the present disclosure. As shown in FIG. 1, the electronic device 10 may include, but is not limited to, a communication device 101, a storage device 102, at least one processor 103, an input/output interface and a bus 105. The least one processor 103 is coupled to the communication device 101, the storage device 102, and the input/output interface 104 through the bus 105, respectively.

The communication device 101 may include a wired communication module and/or a wireless communication module. The wired communication module can provide one or more wired communication solutions such as universal serial bus (USB) and controller area network (CAN). The wireless communication modules can provide one or more of the wireless communication solutions such as wireless fidelity (Wi-Fi), Bluetooth (BT), mobile communication network, frequency modulation (FM), near field communication (NFC), and infrared (IR) technology.

The storage device 102 may include one or more random access memories (RAM) and one or more non-volatile memories (NVM). The random access memory can be directly read and written by the processor 103, and can be used to store executable programs (such as machine instructions) or other running programs, and can also be used to store user and disclosure data. Random access memory can include static random-access memory (SRAM), dynamic random access memory (DRAM), synchronous dynamic random access memory (SDRAM), double data rate synchronous Dynamic random access memory (double data rate synchronous dynamic random access memory, DDR SDRAM), etc.

The non-volatile memory can also store executable programs and user and disclosure data, etc., and can be loaded into the random access memory in advance for direct reading and writing by the processor 103. The non-volatile memory can include disk storage devices and flash memory.

The storage device 102 is used to store one or more computer programs. One or more computer programs are configured for execution by processor 103. The one or more computer programs include a plurality of instructions. When the plurality of instructions is executed by the processor 103, the method for determining temperature of the reflow oven executed on the electronic device 10 can be implemented.

In other embodiments, the electronic device 1 electronic device 10 shown in FIG. 1 also includes an external memory interface for connecting to an external memory to expand the storage capacity of the electronic device 10.

The at least one processor 103 may include one or more processing units. For example, the at least one processor 103 may include a disclosure processor AP, a modem processor, a graphics processing unit (GPU), and an image signal processor (ISP), a controller, a video codec, a digital signal processor (DSP), and/or a neural network processor (NPU), etc. Different processing units can be independent devices or integrated in one or more processors.

The at least one processor 103 provides computing and control capabilities. For example, the at least one processor 103 is used to execute a computer program stored in the storage device 102 to implement the above-mentioned method for determining temperature of the reflow oven.

The input/output interface 104 is used to provide a channel for user input or output. For example, the input/output interface 104 can be used to connect various input and output devices, such as a mouse, a keyboard, a touch device, a display screen, etc., so that the user can enter information, or visualize information.

The bus 105 is at least used to provide a channel for mutual communication among the communication device 101, the storage device 102, the at least one processor 103, and the input/output interface 104 of the electronic device 10.

It can be understood that the structure illustrated in the embodiment of the present disclosure does not constitute a specific limitation on the electronic device 10. In other embodiments of the present disclosure, the electronic device 10 may include more or fewer components than shown in the figures, or some components may be combined, some components may be separated, or some components may be arranged differently. The components illustrated may be implemented in hardware, software, or a combination of software and hardware.

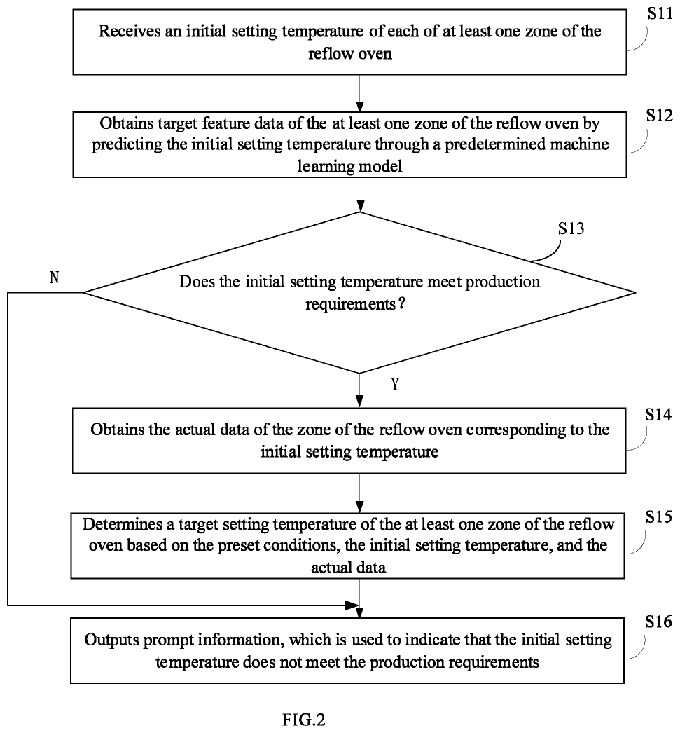

As shown in FIG. 2, a flowchart of a method for determining temperature of reflow oven provided by an embodiment of the present disclosure. Depending on different requirements, an order of blocks in the flowchart can be adjusted according to the actual requirements, and some blocks can be omitted. An implementation body of the method is the electronic device 10 shown in FIG. 1.

Block S11, the electronic device receives an initial setting temperature of each of at least one zone of the reflow oven.

In some embodiments of the present disclosure, the reflow oven may have several zones, and the number of zones in different reflow ovens is different. For example, if the reflow oven includes four zones, such as a zone for preheating, a zone for soaking, a zone for reflowing, and a zone for cooling. The at least one zone of the reflow oven can be one or more of the zones for preheating, the zone for soaking, the zone for reflowing, and the zone for cooling.

In some embodiments of the present disclosure, the initial setting temperature may be a desired temperature of the at least one zone of the reflow oven. After configuring a zone of the reflow oven according to the initial setting temperature, an original temperature of the reflow oven will be changed until the initial setting temperature is reached. The reflow oven configured through the initial setting temperature can be used to produce printed circuit boards and other product devices such as semiconductors, and the present disclosure does not limit this. The electronic device can set the temperature inputted by a user (such as an engineer) on the electronic device as the initial setting temperature.

In other embodiments of the present disclosure, the electronic device may be connected to the reflow oven. For example, the electronic device can be connected to the reflow oven through the bus, the wireless network (Wi-Fi), Bluetooth, etc., so that the electronic device can obtain the initial setting temperature. The initial setting temperature is obtained from a database or an operation log of the reflow oven, and the initial setting temperature at which at least one zone of the reflow oven is configured by the user on the reflow oven (such as on a control panel of the reflow oven).

In some embodiments of the present disclosure, the initial setting temperature of each zone of the reflow oven may be different. For example, if the reflow oven includes four zones, such as the zone for preheating, the zone for soaking, the zone for reflowing, and the zone for cooling. The initial setting temperature of the zone for preheating can be any value from 130° C. to 160° C. The initial setting temperature of the zone for soaking can be any value from 200° C. to 220° C., the initial setting temperature of the zone for reflowing can be any value from 230° C. to 250° C., and the initial setting temperature of the cooling zone can be any value from 30° C. to 40° C.

In this embodiment, the initial setting temperature is only the temperature for configuring each zone of the reflow furnace, and is not equal to an actual temperature of each zone of the reflow furnace. The actual temperature of each zone of the reflow furnace, a speed of temperature variation and a duration of temperature variation are affecting the production quality of printed circuit boards and semiconductors and other devices. In order to ensure the production quality of printed circuit boards and semiconductors and other devices, it is usually necessary to adjust the temperature of each zone of the reflow oven multiple times so that the actual temperature of each zone of the reflow oven meets the requirements for the production of printed circuit boards, semiconductors and other products and devices. The selection of at least one zone of the reflow oven can be determined based on the production process of the printed circuit boards, semiconductors, and other product devices.

Block S12, the electronic device obtains target feature data of the at least one zone of the reflow oven by predicting the initial setting temperature through a predetermined machine learning model.

In some embodiments of the present disclosure, if there are several zones of the reflow oven, the target feature data of the several zones of the reflow oven include, but is not limited to, a slope, a peak temperature, and a duration of each zone. For example, if the at least one furnace zone includes the zone for preheating, the zone for soaking, the zone for reflowing, and the zone for cooling. The target feature data of at least one zone may include a duration for preheating, a slope for preheating, a duration for soaking, and a duration for reflowing, a peak temperature, a duration for cooling duration, a slope for cooling and other data. The target feature data of each zone may be different. For example, the target feature data of the zone for preheating can be the duration for preheating and the slope for preheating, and the target feature data of the for soaking can be the duration for soaking.

In some embodiments of the present disclosure, the machine learning model may be a model obtained by training the machine learning algorithm to convergence using historical setting temperature of at least one zone of the reflow oven and historical feature data corresponding to the historical setting temperature. The machine learning algorithms include, but are not limited to, regression algorithms, decision trees, random forests, support vector machines and other algorithms. A type of the historical feature data is basically the same as the type of the target feature data. For the generation process of the machine learning model, please refer to blocks S21-S25 below.

In some embodiments of the present disclosure, the machine learning algorithm can also be replaced by a deep learning algorithm, such as a convolutional neural network.

In some embodiments of the present disclosure, since the machine learning model is a model obtained by training the machine learning algorithm to convergence using the historical setting temperature of at least one zone of the reflow oven and the historical feature data corresponding to the historical setting temperature. Then the machine learning model obtains a connection relation between the historical setting temperature and the corresponding historical feature data. Therefore, the electronic device uses the machine learning model to predict each initial setting temperature of each zone, and can directly obtain the target feature data corresponding to the initial setting temperature of each zone of the reflow oven. In this embodiment, the target feature data can reflect characteristics such as a change speed, a peak temperature, and a conversion duration between temperatures in each zone of the reflow oven.

Block S13, the electronic device determines whether the initial setting temperature meets production requirements based on preset conditions and the target feature data.

In some embodiments of the present disclosure, the preset conditions may include production indicators corresponding to each target feature data. Each production indicator is used to initially determine whether the initial setting temperature corresponding to the corresponding target feature data meets the production requirements. Each of the production indicator can be a range or a value, which is not limited by this disclosure. When each target feature data is equal to the production indicator or within the range of the production indicator, it is initially determined that the initial setting temperature corresponding to the target feature data meets the production requirements, or, when each target feature data is not equal to the production indicator or out of the range of the production indicator, it is determined that the initial setting temperature corresponding to the target feature data does not meet the production requirements.

In some embodiments of the present disclosure, if there are several zones of the reflow oven, and several target feature data corresponding to the several zones. When each target feature data satisfies the corresponding production indicator, the electronic device determines that each of the several target feature data corresponding to each of the several initial setting temperatures meets the production requirements, or when at least one target feature data does not satisfy the corresponding production indicator, the electronic device determines that the multiple initial setting temperatures corresponding to the several target feature data do not meet the production requirements.

For example, if the target feature data includes a peak temperature of 245° C., a duration for preheating of 30 s, a slope of preheating of 1.2, a duration for soaking of 40 s, a duration for reflowing of 25 s, a duration for cooling of 35 s, and a slope of cooling of −1.5. In the preset conditions, a temperature value range of the production indicator corresponding to the peak temperature is from 240° C. to 275° C., a time duration value range of the production indicator corresponding to the duration for preheating is from 30 s to 60 s, a value range of the production indicator corresponding to the slope of preheating is from 1 to 1.5, and a time duration value range of the production indicator corresponding to the duration for soaking is from 30 s to 60 s, a time duration value range of the production indicator corresponding to the duration for reflowing is from 30 s to 60 s, a time duration value range of the production indicator corresponding to the duration for cooling is from 30 s to 60 s, and a value range of the production indicator corresponding to the slope of cooling is from −1.2 to −1.5. Compare each target feature data with the corresponding production indicator in the preset conditions and determine that the reflow duration of 25 s is outside the time duration value range of the production indicator corresponding to the duration for reflowing. Therefore, the electronic equipment determines that the multiple initial setting temperatures corresponding to the target feature data do not meet the production requirements.

In some embodiments of the present disclosure, if there are several initial setting temperatures, when each initial setting temperature meets the production requirements, the electronic device executes the block S14, or when there is at least one initial setting temperature that does not meet the production requirements. The electronic device executes the block S16.

In this embodiment, since the target feature data can reflect characteristics such as the change speed, the peak temperature, and the conversion duration of the temperatures in each zone of the reflow oven. Therefore, it is possible to preliminarily determine whether the initial setting temperature corresponding to the target feature data meets the production requirements through determining the target feature data.

In other embodiments of the present disclosure, if the production indicator is a range, when there are multiple initial setting temperatures of any one of the zones of the reflow oven, and when the multiple initial setting temperatures meet the production requirements, the electronic device can obtain the target feature data of each initial setting temperature, determine a central value of the range of the production indicator, and select the initial setting temperature corresponding to the target feature data with the smallest distance from the central value as the target setting temperature. For example, if the value range of the production indicator corresponding to the slope of preheating is from 1 to 1.5, a first initial setting temperature of the zone for preheating is 130° C., and the corresponding slope for preheating is 1.3, and a second initial setting temperature of the zone for preheating is 140° C. and the corresponding slope for preheating is 1.4. Since the slope for preheating corresponding to the first initial setting temperature and the slope for preheating corresponding to the second initial setting temperature are both less than a max value of the value range of the production indicator 1.5. Therefore, the first initial setting temperature of 130° C. and the second initial setting temperature of 140° C. both meet the production requirements. The central value of the value range of the production indicator is 1.25, the difference between the slope for preheating 1.3 corresponding to the first initial setting temperature and the central value is 0.05. A first difference between the slope for preheating corresponding to the first initial setting temperature and the central value is 0.15, a second difference between the slope for preheating corresponding to the second initial setting temperature and the central value is 0.05. The second difference is smaller than the first difference, so the first initial setting temperature 130° C. corresponding to the slope for preheating 1.3 can be selected as the target setting temperature.

In this embodiment, by selecting the initial setting temperature corresponding to the target feature data with the smallest distance from the center value as the target setting temperature, the probability that the actual data of the zone of the reflow oven below meets the preset conditions can be improved.

Block S14, the electronic device obtains the actual data of the zone of the reflow oven corresponding to the initial setting temperature.

In some embodiments of the present disclosure, the actual data is a plurality of data collected by a plurality of collection tools disposed in the reflow oven after configuring the reflow oven according to the initial setting temperature. The actual data may include an actual temperature of each zone of the reflow oven and the time corresponding to the actual temperature of each zone of the reflow oven. The collection tools include, but are not limited to, temperature sensors, temperature measurement boards, temperature measurement lines, and thermometers. If there are multiple collection tools, the multiple collection tools can be set at different locations in the reflow oven.

In some embodiments of the present disclosure, the electronic device obtains the actual data of the zone of the reflow oven corresponding to the initial setting temperature includes: the electronic device receives data sent from the collection tools arranged at different locations of at least one zone of the reflow oven, and combines the data received to obtain the actual data. A time-temperature curve can be drawn based on each actual temperature of each zone and the time corresponding to each actual temperature according to the actual data.

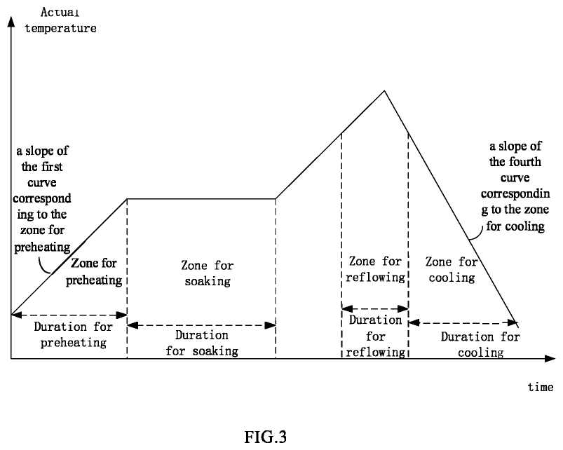

For example, if the reflow oven includes four zones which are the zone for preheating, the zone for soaking, the zone for reflowing, and the zone for cooling. As shown in FIG. 3, which is a schematic diagram of a time-temperature curve provided by an embodiment of the present disclosure. In FIG. 3, an actual oven temperature of the zone for preheating is smaller than an actual oven temperature of the zone for soaking, the actual zone temperature of the zone for soaking is smaller than an actual oven temperature of the zone for reflowing, and an actual furnace temperature of the zone for cooling zone is decreasing based on the actual oven temperature of the zone for reflowing. The actual zone temperature has a linear relationship with time of a first curve corresponding to the zone for preheating, and a slope of a first curve is greater than zero. The actual zone temperature does not change with time of a second curve corresponding to the zone for soaking, and a slope of the second curve is zero. The actual zone temperature has a linear relationship with time of a third curve corresponding to the zone for reflowing and a slope of the third curve is first greater than zero, then equal to zero, and then less than zero. The third curve corresponding to the zone for reflowing has a peak temperature. The actual zone temperature has a linear relationship with time of a fourth curve corresponding to the zone for cooling, and a slope of the fourth curve is less than zero. The common target feature data of the zone for preheating, the zone for soaking, the zone for reflowing, and the zone for cooling may include one or more of the peak temperature, the duration of each zone of the reflow oven, and multiple slopes. The durations include a duration for preheating, a duration for soaking, a duration for reflowing, and a duration for cooling. The slopes include a slope of the first curve corresponding to the zone for preheating and a slope of the fourth curve corresponding to the zone for cooling.

In this embodiment, since multiple collection tools can be arranged at different locations of the reflow oven, data such as the actual temperature at different locations of the reflow oven can be fully collected, thus ensuring comprehensive data of the zones of the reflow oven.

Block S15, the electronic device determines a target setting temperature of the at least one zone of the reflow oven based on the preset conditions, the initial setting temperature, and the actual data.

In some embodiments of the present disclosure, the electronic device determines whether the initial setting temperature meets the production requirements according to the preset conditions and actual feature data corresponding to the actual data of the zone of the reflow oven.

In one embodiment, the data types between the actual feature data and the target feature data are basically the same. The electronic device determines whether the initial setting temperature meets the production requirements based on the preset conditions and the actual feature data corresponding to the actual data of the zone of the reflow oven is the same with the electronic device determines whether the initial setting temperature meets the production requirements based on the preset conditions and target feature data, so the detail description will not be repeated in this disclosure.

In this embodiment, if there are multiple initial setting temperatures, when each initial setting temperature meets the production requirements, the electronic device determines the initial setting temperature of each furnace zone as the target setting temperature, or when there is at least one initial setting temperature that does not meet the production requirements, the electronic device returns to block S12, and continues to predict the initial setting temperature until the multiple initial setting temperatures are all meet the production requirements by using the machine learning model.

In this embodiment, due to the comprehensiveness of the actual data, the initial setting temperature is further judged through the actual data to determine whether setting the initial setting temperature as the target setting temperature, which can increase accuracy and reliability of the target setting temperature. When a device such as a printed circuit board is produced by using the target setting temperature, the production quality of a product such as the printed circuit board can be ensured.

Block S16, the electronic device outputs prompt information, which is used to indicate that the initial setting temperature does not meet the production requirements.

In this embodiment, when the initial setting temperature does not meet the production requirements, the actual data corresponding to the initial setting temperature will not be obtained, thus reducing the need to wait for each furnace zone to cool down before resetting the temperature of the furnace zone of the reflow oven. Thereby reducing the temperature setting time and improving the efficiency of temperature control.

Through the above embodiment, since the machine learning model is trained through the historical setting temperature of the printed circuit board and the historical feature data, the machine learning model can learn the correlation between the temperature and the feature data. When using a machine learning model to predict the initial setting temperature, the reliability of the predicted target feature data can be ensured. Based on the preset conditions and the target feature data, it is determined whether the initial setting temperature meets the production requirements. When the initial setting temperature meets the production requirements, the actual data of the zone of the reflow oven corresponding to the initial setting temperature will be obtained, so that the probability that the initial setting temperature meets the production requirements will be increased. Since when the initial setting temperature does not meet the production requirements, the actual data of the zone of the reflow oven corresponding to the initial setting temperature will not be obtained, so there is a need to wait for each zone of the reflow oven to cool down before resetting the temperature of the zone is reduced, thereby reducing the time for temperature setting and improving the efficiency of temperature control. Determining the target setting temperature of each zone of the reflow oven through the preset conditions, the initial setting temperature, and the actual data of the zone of the reflow oven can further improve the probability that the target setting temperature meets the production requirements. And the printed circuit board production efficiency can be improved when printed circuit boards are produced using accurate target setting temperatures.

In other embodiments of the present disclosure, if the target setting temperature is used to produce printed circuit boards, the method further includes: the electronic device obtains historical yield data of multiple printed circuit boards that are produced and historical time intervals of the multiple printed circuit boards that are input in the zones of the reflow oven. Furthermore, the electronic device calls a preset model to predict the historical yield data and the historical time intervals and obtains the target time intervals of the multiple printed circuit boards.

In at least one embodiment, the historical yield data is used to evaluate the quality of multiple printed circuit boards that have been produced, and the historical time interval is equal to a time interval between any two printed circuit boards entering the reflow oven. The preset models can include, but is not limited to, a regression models and a support vector machine model. Alternatively, the preset model can also be the above-mentioned machine learning model.

The electronic device calls the preset model to predict the historical yield data and the historical time interval, so that the preset model can learn the correlation between the quality of the printed circuit boards and the time interval. Then, the preset model outputs the target time interval is the corresponding time interval with better quality of the printed circuit boards.

In some embodiments of the present disclosure, after obtaining the target setting temperature and the target time interval, the electronic device controls the production of printed circuit boards through the target setting temperature and the target time interval.

In other embodiments of the present disclosure, if the target setting temperature is used to produce printed circuit boards, the user can configure the reflow oven according to the target setting temperature and the target time interval, or the electronic device can configured the reflow oven according to the target setting temperature and the target time interval, so that the reflow oven can generate a board required signal and control a door of the reflow oven to open according to the target time interval. Then a conveyor belt or a board feeding machine can transport the printed circuit boards to the reflow oven according to the board required signal and an opened door of the reflow oven. For example, when the reflow oven generates the board required signal, the door of the reflow oven will open. At this time, the printed circuit boards can be transported to the reflow furnace. After a printed circuit board is transported, the furnace door is closed.

In this embodiment, since the target time interval is equal to the time interval corresponding to better quality of the printed circuit boards, the production of printed circuit boards can be controlled through the target setting temperature and the target time interval to ensure the production quality of the printed circuit boards.

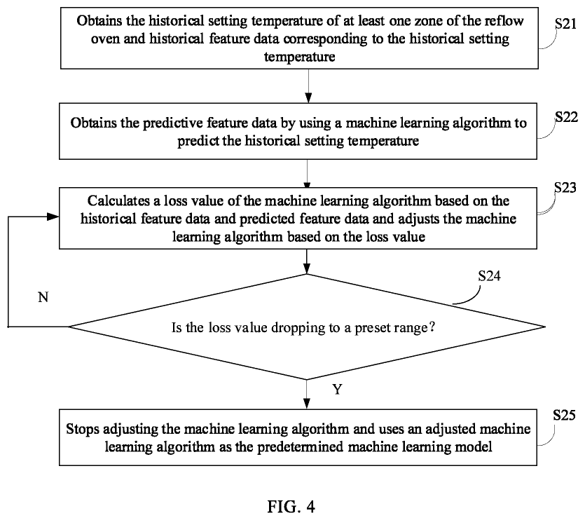

In some embodiments of the present disclosure, before using a preset machine learning model to predict the initial setting temperature, the machine learning model can be obtained by training a machine learning algorithm. For example, as shown in FIG. 4, it is a flow chart of a training method for a machine learning model provided by an embodiment of the present disclosure, which includes the following blocks.

Block S21, the electronic device obtains the historical setting temperature of at least one zone of the reflow oven and historical feature data corresponding to the historical setting temperature.

In some embodiments of the present disclosure, the historical setting temperature corresponds to the initial setting temperature. For example, if the initial setting temperature is the temperature set when printed circuit boards are produced in the reflow oven, the historical setting temperature is the recorded temperature of one or more printed circuit boards that have been produced in the reflow oven. The electronic device can obtain the historical setting temperature from the database or operation log of the reflow oven, and there can be multiple historical setting temperatures.

In some embodiments of the present disclosure, the historical feature data is the feature data of the time-temperature curve of the historical data of the zone of the reflow oven producing one or more printed circuit boards. The data types of historical feature data and predicted feature data are basically the same as target feature data, so the description will not be repeated in this disclosure.

In some embodiments of the present disclosure, the historical data of the zone of the reflow oven may include each historical temperature of each zone of the reflow oven and the historical time corresponding to each historical temperature. The process of obtaining the historical data of the zone of the reflow oven is basically the same as the process of obtaining actual data of the zone of the reflow oven, so this disclosure will not repeat the description.

Block S22, the electronic device obtains the predictive feature data by using a machine learning algorithm to predict the historical setting temperature.

In some embodiments of the present disclosure, machine learning algorithms include, but are not limited to, regression algorithms, decision tree algorithms, random forest algorithms, support vector machines, etc. Alternatively, the machine learning algorithms can be replaced with deep learning algorithms such as convolutional neural networks.

Block S23, the electronic device calculates a loss value of the machine learning algorithm based on the historical feature data and predicted feature data and adjusts the machine learning algorithm based on the loss value.

In some embodiments of the present disclosure, if there are multiple pieces of historical feature data and predicted feature data, the electronic device calculates the loss value of the machine learning algorithm according to errors between the multiple pieces of historical feature data with the corresponding predicted feature data.

In at least one embodiment, the error can be a mean absolute error (MAE), a mean error (ME), a mean square error (MSE), a root mean square error (RMSE), etc. A calculation method of the error can be determined to a type of the error. For example, when the error is the root mean square error, the calculation method of the root mean square error can refer to the following formula:

RMSE=\sqrt{1/nΣᵢ₌₁ⁿ(xᵢ−yᵢ)²}

RMSE represents the root mean square error, n represents the number of multiple historical feature data, xᵢ represents the i-th historical feature data, and yᵢ represents the predicted feature data corresponding to the i-th historical feature data.

Block S24, the electronic device determines whether the loss value is dropping until the loss value is in a preset range.

In some embodiments of this disclosure, the preset range can be set by a user, and this disclosure does not limit this. For example, the preset range can be [0.1, 0.2].

In this embodiment, if the loss value does not drop to the preset range, the electronic device returns to block S22 and continues to use the machine learning algorithm to predict the historical setting temperature. If the loss value drops to the preset range, the electronic device executes block S25.

Block S25, the electronic device stops adjusting the machine learning algorithm and uses an adjusted machine learning algorithm as the machine learning model.

For example, when the loss value is between [0.1, 0.2], the electronic device stops adjusting the machine learning algorithm and uses the adjusted machine learning algorithm as a machine learning model.

In this embodiment, the electronic device trains the machine learning algorithm through the historical setting temperature and historical feature data corresponding to the historical setting temperature, so that the trained machine learning model can learn the association between the setting temperature and the feature data. The adjustment of the machine learning algorithm will only stop when the loss value drops to the preset range, thus ensuring the predictive ability of the machine learning model.

Embodiments of the present disclosure also provide a computer-readable storage medium. A computer program is stored on the computer-readable storage medium. The computer program includes program instructions. The method implemented when the program instructions are executed may refer to the above-mentioned embodiments of the disclosure.

The computer-readable storage medium may be an internal memory of the electronic device of the above embodiment, such as a hard disk or memory of the electronic device. Computer-readable storage media can also be external storage devices of electronic devices, such as plug-in hard drives equipped on electronic devices, smart memory cards (SMC), secure digital (SD) cards, flash memory cards, etc.

In some embodiments, the computer-readable storage medium may include a storage program area and a storage data area, wherein the storage program area may store an operating system, at least one disclosure program required for a function, etc. The storage data area may store data generated according to use of the electronic device.

In the above embodiments, each embodiment is described with its own emphasis. For parts that are not detailed or documented in a certain embodiment, please refer to the relevant descriptions of other embodiments.

Those of ordinary skill in the art will appreciate that the units and algorithm blocks of each example described in conjunction with the embodiments disclosed herein can be implemented with electronic hardware, or a combination of computer software and electronic hardware. Whether these functions are performed in hardware or software depends on the specific disclosure and design constraints of the technical solution. Skilled artisans may implement the described functionality using different methods for each specific disclosure, but such implementations should not be considered beyond the scope of this disclosure.

In the embodiments provided in this disclosure, it should be understood that the disclosed devices/electronic devices and methods can be implemented in other ways. For example, the device/electronic device embodiments described above are only illustrative. For example, the division of modules or units is only a logical function division. In actual implementation, there may be other division methods, such as multiple units. In some implementations, components may be combined or integrated into another system, or some features may be omitted or not implemented. On the other hand, the coupling or direct coupling or communication connection between each other shown or discussed may be through some interfaces, indirect coupling or communication connection of devices or units, which may be in electrical, mechanical, or other forms.

A unit described as a separate component may or may not be physically separate. A component shown as a unit may or may not be a physical unit, that is, it may be located in one place, or it may be distributed to multiple network units. Some or all of the units can be selected according to actual needs to achieve the purpose of the solution of this embodiment.

Finally, it should be noted that the above embodiments are only used to illustrate the technical solutions of the present disclosure and are not limiting. Although the present disclosure has been described in detail with reference to the preferred embodiments, those of ordinary skill in the art should understand that the technical solutions of the present disclosure can be modified. Modifications or equivalent substitutions may be made without departing from the spirit and scope of the technical solution of the present disclosure.

What is claimed is:

1. A method for determining temperature of a reflow oven, the method comprising:
receiving an initial setting temperature of each of at least one zone of the reflow oven;
obtaining target feature data of each of the at least one zone of the reflow oven by predicting the initial setting temperature through a predetermined machine learning model;
determining whether the initial setting temperature meets production requirements based on preset conditions and the target feature data;
obtaining actual data of each of the at least one zone of the reflow oven corresponding to the initial setting temperature in response that the initial setting temperature meets the production requirements; and
determining a target setting temperature of each of the at least one zone of the reflow oven based on the preset conditions, the initial setting temperature, and the actual data.

2. The method according to claim 1, wherein the target feature data comprises a slope, a peak temperature, and a duration of each of the at least one zone of the reflow oven.

3. The method according to claim 2, wherein determining whether the initial setting temperature meets production requirements based on preset conditions and the target feature data further comprises:
in response that the slope, the peak temperature, and the duration of each of the at least one zone of the reflow oven meet the preset conditions, determining that the initial setting temperature meets the production requirements.

4. The method according to claim 1, wherein before predicting the initial setting temperature through the predetermined machine learning model, the method further comprises:
obtaining a historical setting temperature of each of the at least one zone of the reflow oven and historical feature data corresponding to the historical setting temperature;
obtaining predictive feature data by predicting the historical setting temperature through a machine learning algorithm;
calculating a loss value of the machine learning algorithm according to the historical feature data and the predictive feature data;
adjusting the machine learning algorithm according to the loss value until the loss value drops to a preset range; and
setting the adjusted machine learning algorithm as the predetermined machine learning model.

5. The method according to claim 4, wherein calculating the loss value of the machine learning algorithm according to the historical feature data and the predictive feature data further comprises:
calculating the loss value based on errors between the historical feature data and corresponding predictive feature data.

6. The method according to claim 1, wherein obtaining actual data of each of the at least one zone of the reflow oven corresponding to the initial setting temperature further comprises:
receiving data sent from a plurality of collection tools arranged at different locations of the each of the at least one zone of the reflow oven; and
obtaining the actual data by combining the data.

7. The method according to claim 1, wherein determining the target setting temperature of each of the at least one zone of the reflow oven based on the preset conditions, the initial setting temperature, and the actual data further comprises:
determining a central value of a range of a production indicator of the preset conditions; and
selecting the initial setting temperature corresponding to the target feature data with a smallest distance from the central value as the target setting temperature.

8. An electronic device comprising:
a storage device;
at least one processor, wherein
the storage device stores one or more programs, which when executed by the at least one processor, cause the at least one processor to:
receive an initial setting temperature of each of at least one zone of the reflow oven;
obtain target feature data of each of the at least one zone of the reflow oven by predicting the initial setting temperature through a predetermined machine learning model;
determine whether the initial setting temperature meets production requirements based on preset conditions and the target feature data;
obtain actual data of each of the at least one zone of the reflow oven corresponding to the initial setting temperature in response that the initial setting temperature meets the production requirements, and
determine a target setting temperature of each of the at least one zone of the reflow oven based on the preset conditions, the initial setting temperature, and the actual data.

9. The electronic device according to claim 8, wherein the target feature data comprises a slope, a peak temperature, and a duration of each of the at least one zone of the reflow oven.

10. The electronic device according to claim 9, wherein the at least one processor determines whether the initial setting temperature meets production requirements based on preset conditions and the target feature data by:
in response that the slope, the peak temperature, and the duration of each of the at least one zone of the reflow oven meet the preset conditions, determining that the initial setting temperature meets the production requirements.

11. The electronic device according to claim 8, wherein before the at least one processor predicts the initial setting temperature through the predetermined machine learning model, the at least one processor is further caused to:
obtain a historical setting temperature of each of the at least one zone of the reflow oven and historical feature data corresponding to the historical setting temperature;
obtain predictive feature data by predicting the historical setting temperature through a machine learning algorithm;
calculate a loss value of the machine learning algorithm according to the historical feature data and the predictive feature data;
adjust the machine learning algorithm according to the loss value until the loss value drops to a preset range; and
set the adjusted machine learning algorithm as the predetermined machine learning model.

12. The electronic device according to claim 11, wherein the at least one processor calculates the loss value of the machine learning algorithm according to the historical feature data and the predictive feature data by:
calculating the loss value based on errors between the historical feature data and corresponding predictive feature data.

13. The electronic device according to claim 8, wherein the at least one processor obtains actual data of each of the at least one zone of the reflow oven corresponding to the initial setting temperature by:
receiving data sent from a plurality of collection tools arranged at different locations of the each of the at least one zone of the reflow oven; and
obtaining the actual data by combining the data.

14. The electronic device according to claim 8, wherein the at least one processor determines the target setting temperature of each of the at least one zone of the reflow oven based on the preset conditions, the initial setting temperature, and the actual data by:
determining a central value of a range of a production indicator of the preset conditions; and
selecting the initial setting temperature corresponding to the target feature data with a smallest distance from the central value as the target setting temperature.

15. A non-transitory storage medium having instructions stored thereon, when the instructions are executed by a processor of an electronic device, the processor is caused to perform a method, wherein the method comprises:
receiving an initial setting temperature of each of at least one zone of the reflow oven;
obtaining target feature data of each of the at least one zone of the reflow oven by predicting the initial setting temperature through a predetermined machine learning model;
determining whether the initial setting temperature meets production requirements based on preset conditions and the target feature data;
obtaining actual data of each of the at least one zone of the reflow oven corresponding to the initial setting temperature in response that the initial setting temperature meets the production requirements; and
determining a target setting temperature of each of the at least one zone of the reflow oven based on the preset conditions, the initial setting temperature, and the actual data.

16. The non-transitory storage medium according to claim 15, wherein the target feature data comprises a slope, a peak temperature, and a duration of each of the at least one zone of the reflow oven.

17. The non-transitory storage medium according to claim 16, wherein determining whether the initial setting temperature meets production requirements based on preset conditions and the target feature data further comprises:
in response that the slope, the peak temperature, and the duration of each of the at least one zone of the reflow oven meet the preset conditions, determining that the initial setting temperature meets the production requirements.

18. The non-transitory storage medium according to claim 15, wherein before predicting the initial setting temperature through the predetermined machine learning model, the method further comprises:
obtaining a historical setting temperature of each of the at least one zone of the reflow oven and historical feature data corresponding to the historical setting temperature;
obtaining predictive feature data by predicting the historical setting temperature through a machine learning algorithm;
calculating a loss value of the machine learning algorithm according to the historical feature data and the predictive feature data;
adjusting the machine learning algorithm according to the loss value until the loss value drops to a preset range; and
setting the adjusted machine learning algorithm as the predetermined machine learning model.

19. The non-transitory storage medium according to claim 18, wherein calculating the loss value of the machine learning algorithm according to the historical feature data and the predictive feature data further comprises:
calculating the loss value based on errors between the historical feature data and corresponding predictive feature data.

20. The non-transitory storage medium according to claim 15, wherein obtaining actual data of each of the at least one zone of the reflow oven corresponding to the initial setting temperature further comprises:
receiving data sent from a plurality of collection tools arranged at different locations of the each of the at least one zone of the reflow oven; and
obtaining the actual data by combining the data.
